(19) United States
(12) Patent Application Publication
(10) Pub. No.: US 2026/0156228 A1
(43) Pub. Date: Jun. 4, 2026

(54) DYNAMIC PROJECTION SURFACE SYSTEM AND METHOD

(71) Applicant: Universal City Studios LLC, Universal City, CA (US)

(72) Inventor: Mikey Arana, Orlando, FL (US)

(21) Appl. No.: 19/406,839

(22) Filed: Dec. 2, 2025

Related U.S. Application Data
(60) Provisional application No. 63/727,999, filed on Dec. 4, 2024.

(51) Int. Cl. H04N 5/74; G03B 21/14

(52) U.S. Cl. CPC H04N 5/74; G03B 21/145

(57) ABSTRACT

A dynamic projection surface system includes a projection surface assembly having one or more projection surfaces configured to display imagery and a dynamic surface assembly configured to move relative to the one or more projection surfaces. The system also includes one or more three-dimensional (3D) features extending from one or more dynamic surfaces of the dynamic surface assembly, where the dynamic projection surface system is configured to translate at least the dynamic surface assembly or the projection surface assembly between a separated configuration in which the one or more projection surfaces is offset from the one or more dynamic surfaces and a combined configuration in which the one or more dynamic surfaces engages with the one or more projection surfaces such that the one or more 3D features protrude into the one or more projection surfaces. The system also includes one or more projectors to project the imagery onto the one or more projection surfaces.

### CROSS-REFERENCE TO RELATED APPLICATION

This application claims priority to and the benefit of U.S. Provisional Application No. 63/727,999 entitled “DYNAMIC PROJECTION SURFACE SYSTEM AND METHOD” and filed Dec. 4, 2024, which is incorporated by reference herein in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks and other entertainment venues often provide a selection of unique attractions. For example, an amusement park may include a variety of attractions, such as rides, exhibits, restaurants, and show performances, to entertain guests. In many instances, the attractions may include respective attraction environments with features of interest, including displays (e.g., projections), to enhance guest experiences.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a dynamic projection surface system includes a projection surface assembly having one or more projection surfaces configured to display imagery and a dynamic surface assembly configured to move relative to the one or more projection surfaces. The system also includes one or more three-dimensional (3D) features extending from one or more dynamic surfaces of the dynamic surface assembly, where the dynamic projection surface system is configured to translate at least the dynamic surface assembly or the projection surface assembly between a separated configuration in which the one or more projection surfaces is offset from the one or more dynamic surfaces and a combined configuration in which the one or more dynamic surfaces engages with the one or more projection surfaces such that the one or more 3D features protrude into the one or more projection surfaces. The system also includes one or more projectors to project the imagery onto the one or more projection surfaces.

In an embodiment, a dynamic projection surface system for an entertainment venue includes a dynamic surface assembly configured to move one or more three-dimensional (3D) features along a dynamic surface of the dynamic surface assembly. The system also includes a projection surface assembly comprising a projection surface configured to contact at least one of the one or more 3D features in a combined configuration in which the projection surface assembly and the dynamic surface assembly are engaged. The system also includes a first actuator configured to translate the dynamic surface and/or the projection surface between the combined configuration and a separated configuration where the dynamic surface assembly is offset from the projection surface assembly. The system further includes a projector configured to project imagery onto the projection surface.

In an embodiment, a projection system includes a projection surface assembly having a projection surface. The system also includes a projector to project a projection image onto the projection surface and a dynamic surface assembly to interact with the projection surface assembly in a combined configuration. The dynamic surface assembly includes one or more rollers, a dynamic surface extending around the one or more rollers, and one or more three-dimensional (3D) features coupled to the dynamic surface. The one or more 3D features may protrude into the projection surface in the combined configuration. The system further includes a dynamic surface actuator coupled to at least one roller of the one or more rollers, wherein the dynamic surface actuator is configured to rotate the at least one roller to rotate the dynamic surface.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a schematic exploded perspective view of an embodiment of a dynamic projection surface system, in accordance with the present disclosure;

FIG. 2 is a schematic perspective view of an embodiment of an attraction including a dynamic projection surface system, in accordance with the present disclosure;

FIG. 3 is a schematic perspective view of an embodiment of a walkthrough attraction including a dynamic projection surface system, in accordance with the present disclosure;

FIG. 4 is a schematic exploded perspective view of an embodiment of a dynamic projection surface system, in accordance with the present disclosure; and

FIG. 5 is a schematic exploded perspective view of an embodiment of a dynamic projection surface system in a combined configuration and a separated configuration, in accordance with the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It is presently recognized that guests of an entertainment venue may participate in various attractions, such as rides, walkthrough attractions, and show performances, throughout the entertainment venue. It is also presently recognized that the attractions throughout the entertainment venue may include an attraction environment including various themes, decorations, and/or designs to enhance guest experience. As such, it is also presently recognized it would be desirable to utilize three-dimensional (3D) visual effects within the attraction environment to further enhance guest experiences. In accordance with present embodiments, such 3D visual effects may be dynamic and coordinate with image projection or display (e.g., projection mapping) to create a more interesting and/or immersive experience.

The present disclosure is directed to a dynamic projection surface system (DPSS), which may include a projector, a projection surface assembly (e.g., scrim, screen, sheet, weave), and a dynamic surface assembly (e.g., belt conveyor, treadmill). The DPSS may also include an actuator system having one or more actuators that operate to position (e.g., orient, move, tighten, loosen, cycle) various aspects of the DPSS to achieve different modes of operation. The projector (e.g., a video projector, LCD projector) may use light to project imagery onto the projection surface, which sufficiently reflects the imagery for viewing. The projection surface assembly may include a projection surface, such as a sheet or layer of material (e.g., an elastic or substantially elastic material) suitable for reflecting projected imagery and may be designed to cover, drape over, and/or conformingly engage the dynamic surface. The dynamic surface assembly may include one or more 3D features (e.g., texturing, attachments, objects, actuatable pop-ups) integrated with, attached to, and/or fixed to a dynamic surface (e.g., a conveyor belt). The dynamic surface assembly is operable to move such 3D features along one or more trajectories to provide visual kinetic activity. Coordinated operation of these components of the DPSS may include projecting imagery (e.g., animation) onto the projection surface, which may be engaged with or disengaged from the dynamic surface (e.g., via the actuator system), to provide various visual presentations and combined effects. Different visual presentations and combined effects may be provided via different DPSS modes of operation and conditions within such modes.

The DPSS may change the relative positioning of the projection surface assembly and the dynamic surface assembly to achieve the different modes of operation. For example, the DPSS may be configured to engage the projection surface with the dynamic surface in a combined configuration (e.g., 3D orientation) or separate (e.g., offset) the projection surface and the dynamic surface in a separated configuration. These different configurations may facilitate provision of various aesthetics for the DPSS and associated visual presentations. The engagement or separation of the projection surface and the dynamic surface may be achieved by moving one or both of the projection surface assembly and/or the dynamic surface assembly via the actuation system. Thus, the actuation system may facilitate switching between modes of operation.

The combined configuration may include levels of engagement between the projection surface and the dynamic surface. For example, the combined configuration may include the projection surface tightly engaging with the dynamic surface such that the projection surface conforms about 3D features (e.g., objects or components) extending from the dynamic surface. In other words, the 3D features may extend into the projection surface, deforming the projection surface and creating corresponding protrusions, which may be described as 3D imprints in the projection surface. In the combined configuration, the projector may use projection mapping technology to display projection imagery on the projection surface, where the projection imagery includes image portions that align with the protrusions, including transitioning the image portions with movement of the protrusions. This allows for added immersion of guests in the experience by layering kinetics and projected imagery to provide more impactful effects. The combined configuration may also include the projection surface only lightly engaging with the dynamic surface such that the dynamic surface creates some physical interaction with the projection surface (e.g., causing ripples from minor physical interfaces between moving features on the dynamic surface and the projection surface or from generated airflow).

In the separated configuration, the 3D features of the dynamic surface may not protrude through the projection surface, and the projector may display a projection image onto the projection surface which is substantially flat or two-dimensional (2D). The separated configuration may include the projection surface extending separately from the dynamic surface in various conditions. For example, the projection surface may be stretched taut (e.g., via one or more actuators of the actuator system) such that it presents a flattened surface onto which images can be projected. As another example, the projection surface may be loosely held (e.g., held with slack) and allowed to dangle, which may facilitate generation of a ripple effect along the projection surface based on indirect interactions with the dynamic surface (e.g., airflow generated by movement of the dynamic surface) or interactions with a different component, such as a fan. As an example, this loose condition of the projection surface may be utilized with projection imagery of water to depict a water flow and associated physical ripples.

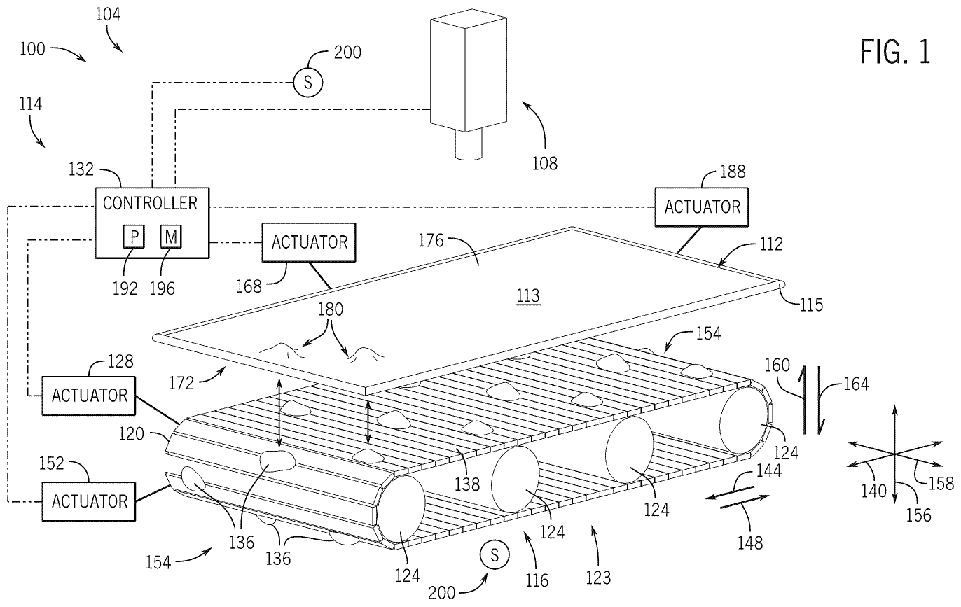

With the preceding in mind, FIG. 1 is a schematic perspective view of an embodiment of a dynamic projection surface system (DPSS) 100 that may be located within an entertainment venue 104. As briefly discussed above, the DPSS 100 may include a projector 108, a projection surface assembly 112 including a projection surface 113 and a projection surface support 115 (e.g., frame), and a dynamic surface assembly 116 including a dynamic surface 120 (e.g., belt). The projector 108 may be distanced (e.g., variably distanced) from the projection surface 113 and configured to project imagery (e.g., a projection image or video) onto the projection surface 113 while the projection surface assembly 112 is engaged with (in the combined configuration) or separated from (in the separated configuration) the dynamic surface assembly 116 to create one or more visual effects. It should be noted that positioning of the projector 108 may be changed to facilitate desired performance characteristics (e.g., projection angles or focusing of imagery) and that such adjustments may be performed by an actuation system 114, which may include one or more actuators. As will be appreciated, in the combined configuration, the projection surface assembly 112 in combination with the dynamic surface assembly 116 may create a 3D condition of the projection surface 113 (e.g., with protrusions in the projection surface 113) enabling layering of imagery from the projection image on the projection surface 113 and 3D kinetic effects provided by the dynamic surface assembly 116.

In an embodiment, the dynamic surface assembly 116 may include a dynamic surface (e.g., moving surface, belt, tread), a chassis 123, and one or more rollers 124. The dynamic surface 120 may be driven by the one or more rollers 124 to circulate or rotate around the chassis 123 of the dynamic surface assembly 116. In other embodiments, the dynamic surface assembly 116 may include features that facilitate different or additional types of motion (e.g., lateral sliding, rotation about an axis, sway, lift, combined motions). As such, the dynamic surface assembly 116 may include one or more dynamic surface actuator 128 (e.g., an actuator of the actuator system 114) configured to move the dynamic surface assembly 116. In the illustrated embodiment, the dynamic surface actuator 128 may be configured to circulate or rotate the dynamic surface 120 around or over the one or more rollers 124. Specifically, a controller 132 of the DPSS 100 may be communicatively coupled to the dynamic surface actuator 128 and may be configured to instruct the dynamic surface actuator 128 to move, adjust, or otherwise circulate the dynamic surface 120 around the rollers 124. For example, the dynamic surface actuator 128 may be coupled to at least one roller of the one or more rollers 124 and may be configured to rotate the at least one roller to circulate the dynamic surface 120 in a continuous manner. One or more 3D features 136 (e.g., objects, extensions) may extend from the dynamic surface 120 (e.g., a front face 138 of the dynamic surface 120) and may be configured to circulate, translate, or otherwise move with the circulation of the dynamic surface 120. In other words, the dynamic surface actuator 128 may operate the dynamic surface 120 to continuously rotate or circulate the 3D features 136 around the chassis 123 of the dynamic surface assembly 116. In an embodiment, one or more of the 3D features 136 may also be actuatable (e.g., operable to extend or retract relative to the front face 138 of the dynamic surface 120).

In an embodiment, the dynamic surface actuator 128 rotates the one or more rollers 124 to translate the dynamic surface 120 (e.g., a front face 138 of the dynamic surface 120) in a direction along the horizontal axis 140. For example, the dynamic surface actuator 128 may rotate the rollers 124 in a counter-clockwise direction to translate a portion of the dynamic surface 120 facing the projection surface assembly 112 in a first direction 144. The dynamic surface actuator 128 may also rotate the rollers 124 in a clockwise direction to translate the portion of the dynamic surface 120 facing the projection surface assembly 112 in a second direction 148, opposite the first direction 144. As a result of the multi directional movement of the dynamic surface 120, the 3D features 136 fixed or coupled to the dynamic surface 120 may also move in a direction along the horizontal axis 140. As will be appreciated, the dynamic surface assembly 116 may be positioned (e.g., during installation or via the actuator system 114) in any suitable manner, such as vertically or horizontally, and the dynamic surface 120 may be configured to circulate in any direction, such as along the horizontal axis 140, the vertical axis 156, or a third-dimensional axis 158 (e.g., depth axis) to achieve desired visual kinetics, which can be combined with projected imagery to provide desired aesthetics for the DPSS 100.

The dynamic surface assembly 116 may include any number of rollers 124 suitable to translate and support the dynamic surface 120 in an operating mode of the dynamic surface assembly 116. In an embodiment, the number, size, and placement of the rollers 124 may depend on a size (e.g., width, length) of the dynamic surface 120. Although four rollers 124 are illustrated in the illustrated embodiment, it will be appreciated that a greater or fewer number of rollers 124 may be utilized. For example, a longer dynamic surface 120 may utilize an increased number of rollers 124, compared to a dynamic surface 120.

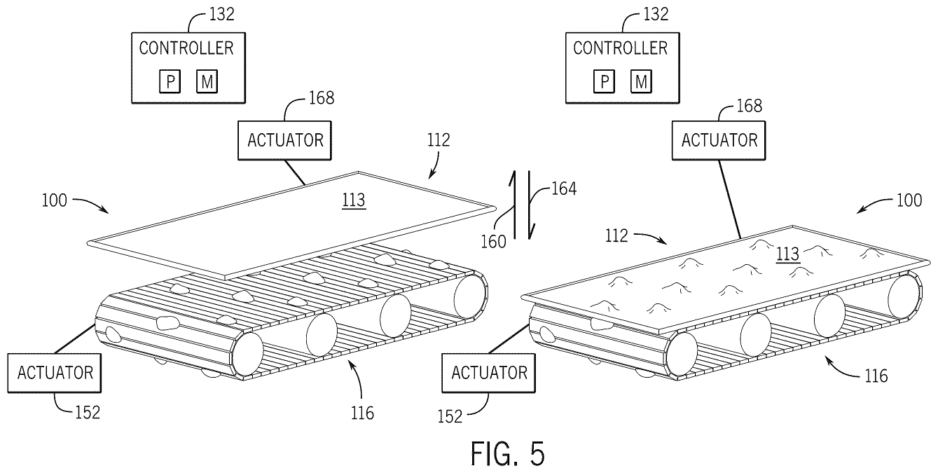

In an embodiment, the dynamic surface assembly 116 may include an engagement actuator 152 (e.g., an actuator of the actuator system 114) configured to translate the dynamic surface assembly 116 in a direction along the vertical axis 156 into and out of engagement with the projection surface 113. For example, the controller 132 may instruct the engagement actuator 152 to translate the dynamic surface assembly 116 in a first direction 160 or a second direction 164, opposite the first direction 160. In this way, the engagement actuator 152 may translate the dynamic surface assembly 116 in the first direction 160 (e.g., upward relative to a direction of gravity) to contact or combine with the projection surface 113 positioned above the dynamic surface assembly 116 in the combined configuration, as illustrated in FIG. 5. The engagement actuator 152 may also translate the dynamic surface assembly 116 in the second direction (e.g., downward relative to the direction of gravity) to separate (e.g., offset) from the projection surface 113 in the separated configuration. In this way, the controller 132 may transition the DPSS 100 between the combined configuration and the separated configuration of the DPSS 100 based on a desired visual effect (e.g., 3D visual effect, 2D visual effect). It should be noted that, in an embodiment, the engagement actuator 152 may be used to move the projection surface assembly 112 relative to the dynamic surface assembly 116 instead of moving the dynamic surface assembly 116. Further, in an embodiment, the engagement actuator 152 may move both the projection surface assembly 112 and the dynamic surface assembly 116 to facilitate transitioning between the combined and separated configurations.

As discussed above, the dynamic surface assembly 116 may include one or more 3D features 136 that may be circulated or rotated around the chassis 123 of the dynamic surface assembly 116 on the dynamic surface 120. The 3D features 136 extending from a face of the dynamic surface 120 may be fixed thereon in any suitable manner, such as, mechanical coupling (e.g., fasteners), chemical adhesives, magnetic coupling, welding, actuatable engagement (e.g., attachment via an activation spring), or any combination thereof. In an embodiment, the 3D feature 136 may be a part of or a component of the dynamic surface 120, such as a tread of the dynamic surface 120. As will be appreciated, the shape, size, and number of the 3D features 136 may depend on a desired visual effect of the DPSS 100. For example, in order to produce a water like visual effect, the 3D features 136 may be shaped (e.g., contoured) and/or sized to produce a wave like 3D visual effect in the combined configuration. Further, the number of 3D features 136 may be correlated to certain characteristics of the 3D visual effect, such as a number or type of fluid characteristics, such as ripples or waves. As another example, the shape, size, and/or number of the 3D features 136 may be adjusted in order to produce a lava like 3D visual effect of the DPSS 100. Indeed, the size, shape, number, and positioning of the 3D features 136 may be adjusted to simulate, imitate, or otherwise create any suitable visual effect, including but not limited to states of matter (e.g., solids, liquids, gases), phase transitions (e.g., melting, freezing, vaporization), natural substances (e.g., water, lava, ice, soil, sand, stones), forms of energy (e.g., fire, plasma), animated objects (e.g., animals, swaying plants), inanimate objects (e.g., statues, buildings seen from far overhead), and so forth.

In an embodiment, the 3D features 136 may include one or more integrated lights, speakers, and/or actuators (e.g., vibrational elements, extension elements, rotational elements). For example, the 3D features 136 may include lights configured to emit light through the projection surface 113 to enhance an associated 3D visual effect. In an embodiment, the 3D features 136 may be broken up or separated (e.g., hinged or segmented) to facilitate movement over edges 154 of the chassis 123. In this way, the movement of the 3D features 136 over the edges 154 may not be inhibited, enabling larger 3D features 136 to be used or positioned on the dynamic surface 120. For example, a 3D feature 136 corresponding to a snake may be separated into multiple segments that combine as a unified element when positioned on the dynamic surface 120 such that they face the projection surface 113 but expand apart while traversing the edges 154, facilitating the transition of the snake around the chassis 123.

In an embodiment, the 3D features 136 may include consistent shapes and sizes throughout the dynamic surface 120 of the dynamic surface assembly 116. As a result, the DPSS 100 may produce consistent or non-random visual effects. In an embodiment, the shape and size of the 3D features 136 may be different or sporadic throughout the dynamic surface 120 of the dynamic surface assembly 116. In this way, the DPSS 100 may produce visual effects that realistically simulate random natural occurrences (e.g., water flowing, lava flowing).

As briefly discussed above, the DPSS 100 includes the projection surface assembly 112 configured to display the projection image from the projector 108 onto a projection surface 113. The projection surface 113 may be configured to interact or combine with the dynamic surface 120 in the combined configuration. In an embodiment, the projection surface 113 may be substantially stationary, and the dynamic surface assembly 116 may vertically translate, via the engagement actuator 152, in the first direction 160 to combine with (e.g., abut, engage) the projection surface 113. As will be appreciated, by maintaining the projection surface 113 at a constant vertical position, while translating the dynamic surface assembly 116, certain mechanisms (e.g., the dynamic surface 120 with 3D features 136) of the DPSS 100 may not be revealed to a guest viewing the projection image. As such, the projection surface 113 may maintain an appearance of a non-dynamic floor or wall, while the dynamic surface assembly 116 may translate (e.g., vertically, horizontally) behind the projection surface 113 (e.g., mock wall, mock flooring, mock ceiling), unseen by the guest or viewer. Further, by maintaining the positioning of the projection surface 113, focus of the projector 108 may not require adjustments. However, in some embodiments, the projection surface assembly 112 may be moved to facilitate transitioning between configurations.

In an embodiment, the DPSS 100 may include a projection surface actuator 168 (e.g., an actuator of the actuation system 114) configured to translate the projection surface assembly 112 in a direction (e.g., along the vertical axis 156). For example, the controller 132 may instruct the projection surface actuator 168 to translate the projection surface assembly 112 in the first direction 160 or the second direction 164, opposite the first direction 160. In this way, the projection surface actuator 168 may translate the projection surface assembly 112 in the second direction 164 (e.g., downward relative to the direction of gravity) to contact or combine (e.g., engage, abut) with the dynamic surface 120 positioned below the projection surface assembly 112 in the combined configuration. The projection surface actuator 168 may also translate the projection surface assembly 112 in the first direction 160 to separate from the dynamic surface assembly 116 in the separated configuration.

In the combined configuration, the projection surface 113 may combine or drape over the dynamic surface 120 and the 3D features 136 disposed thereon. As the 3D features 136 contacts a first side 172 (e.g., bottom side) of the projection surface 113, the 3D features 136 may create one or more protrusions 180 in the second side 176 (e.g., top side) of the projection surface 113 when in the combined configuration. In some embodiments (e.g., when the projection surface 113 is porous), the 3D features 136 may extend through the projection surface 113 and be exposed on the other side. The protrusions 180 may generally take the same shape and size as the 3D features 136 below or engaged with the projection surface 113. However, during operation or movement of the dynamic surface 120, while in the combined configuration, different characteristics may influence the shape of the protrusions 180 and/or other aspects of the projection surface 113. For example, varying levels of engagement between the 3D features 136 and the projection surface 113, flexibility of the material forming the projection surface 113, and tautness of the projection surface 113 may cause extended deformation of the projection surface (e.g., elongate ridges formed by stretching of the projection surface 113). The second side 176 of the projection surface 113 may be 3D or “bumpy” in the combined configuration with the dynamic surface 120. Further, the projector 108 may project a projection image onto the second side 176 of the projection surface 113 that produces a physically and/or kinetically enhanced 3D visual effect in the combined configuration. In the separated configuration, the second side 176 may not include protrusions 180, and the projection surface 113 may be substantially smooth or 2D. In the separated configuration, the projector 108 may project a projection image onto the second side 176 of the projection surface 113 that produces a 2D visual effect or a standard 3D visual effect without supporting physical protrusions or related kinematics.

As discussed above, the dynamic surface assembly 116 may include the dynamic surface actuator 128 configured to rotate rollers 124 to circulate or rotate the dynamic surface 120 including the 3D features 136 around the chassis 123. In the combined configuration of the projection surface assembly 112 and the dynamic surface assembly 116, the operation of the dynamic surface actuator 128 may cause the protrusions 180 to move along the projection surface 113. For example, in the combined configuration, while the dynamic surface 120 is in operation, the 3D features 136 may move in the first direction 144 or the second direction 148, thereby causing the protrusions 180 to move in the first direction 144 or the second direction 148, respectively. In this way, the projector 108 may project a projection image onto the second side 176 of the projection surface 113 that produces a dynamic or moving 3D visual effect with the protrusions 180. The dynamic 3D visual effect may be a 3D water effect, a 3D lava effect, a 3D sand effect, a 3D snow effect, and the like.

In an embodiment, the tension of the projection surface 113 may be adjusted to revise the visual impact of the DPSS 100. For example, the projection surface 113 with increased tension (e.g., tighter, taut condition) may produce differently shaped or sized protrusions 180 compared to the projection surface 113 with less tension (e.g., looser, with slack, slack condition). As such, in an embodiment, the projection surface assembly 112 may include the projection surface support 115 (e.g., frame) configured to support the projection surface 113, including supporting the projection surface 113 at a desired tension level. Further, the projection surface assembly 112 may include a tension actuator 188 (e.g., an actuator of the actuation system 114) configured to adjust the tension of the projection surface 113. For example, the tension actuator 188 (e.g., a roller actuator) may be coupled to the projection surface support 115, and may be configured to wind the projection surface 113 about a roller, increasing tension, and unwind the projection surface 113 from the roller, decreasing tension. The tension actuator 188 may be communicatively coupled to the controller 132, where the controller 132 may be configured to instruct the tension actuator 188 to adjust the tension of the projection surface 113 based on a desired 3D visual effect.

The projection surface 113 may include any suitable material configured to visually display the projection image from the projector 108 and enable the 3D features 136 to protrude into the projection surface 113. For example, the projection surface 113 may comprise elastic material, such as an elastic fabric, configured to change tension while maintaining a constant projection surface area. Thus, the tension actuator 188 may adjust the tension of the projection surface 113 while maintaining a constant area of the projection surface 113 over or adjacent to the dynamic surface assembly 116.

The projector 108 may include any suitable type of projector for providing the projection image onto the projection surface 113. For example, the projector 108 may comprise a digital light processing (DLP) projector, liquid crystal display (LCD) projector, LED projector, liquid crystal on silicon (LCoS) projector, short, medium, or long throw projectors and so forth. The projector 108 may be positioned at any distance away from the projection surface 113 to desirably project the projection image onto the projection surface 113. In an embodiment, more than one projector 108 may be used to project a projection image or multiple projection images onto the projection surface 113. Indeed, as discussed further below, more than one projector 108 may be utilized in sync while performing 3D projection mapping onto the projection surface 113 in the combined configuration. Indeed, the projector 108 may include one or more projectors.

As discussed above, the controller 132 may be communicatively coupled to one or more components of the DPSS 100 and may be configured to monitor, adjust, and/or otherwise control operation of the components (e.g., the projector 108, the actuator system 114) of the DPSS 100. For example, one or more control transfer devices, such as wires, cables, wireless communication devices, and the like, may communicatively couple the components of the DPSS 100 (e.g., projector 108, any actuator or combination of actuators of the actuator system 114) to the controller 132. That is, one or more components of the DPSS 100 may each have one or more communication components that facilitate wired or wireless (e.g., via a network) communication with the controller 132.

In some embodiments, the communication components may include a network interface that enables the components of the DPSS 100 to communicate via various protocols such as EtherNet/IP, ControlNet, DeviceNet, or any other communication network protocol. Alternatively, the communication components may enable the components of the DPSS 100 to communicate via mobile telecommunications technology, Bluetooth®, near-field communications technology, and the like. As such, one or more components of the DPSS 100 may wirelessly communicate data between each other. In other embodiments, operational control of certain components of the DPSS 100 may be regulated by one or more relays or switches (e.g., a 24 volt alternating current [VAC] relay).

The controller 132 is configured to control components of the DPSS 100 in accordance with the techniques discussed herein. The controller 132 includes processing circuitry 192, such as a microprocessor, which may execute software for controlling the components of the DPSS 100. The processing circuitry 192 may include multiple microprocessors, one or more “general-purpose” microprocessors, one or more special-purpose microprocessors, and/or one or more application specific integrated circuits (ASICS), or some combination thereof. For example, the processing circuitry 192 may include one or more reduced instruction set (RISC) processors.

The controller 132 also include a memory device 196 (e.g., a memory) that may store information, such as instructions, control software, look up tables, configuration data, etc. The memory device 196 may include a volatile memory, such as random access memory (RAM), and/or a nonvolatile memory, such as read-only memory (ROM). The memory device 196 may store a variety of information and may be used for various purposes. For example, the memory device 196 may store processor-executable instructions including firmware or software for the processing circuitry 192 to execute, such as instructions for controlling components of the DPSS 100. In some embodiments, the memory device 196 is a tangible, non-transitory, machine-readable-medium that may store machine-readable instructions for the processing circuitry 192 to execute. The memory device 196 may include ROM, flash memory, a hard drive, or any other suitable optical, magnetic, or solid-state storage medium, or a combination thereof. The memory device 196 may store data, instructions, and any other suitable data.

In an embodiment, the controller 132 may instruct the projector 108 to produce the projection image based on the orientation of the projection surface assembly 112 and the dynamic surface assembly 116. For example, upon instructing the engagement or the projection surface actuators 152, 168 to translate the dynamic surface assembly 116 and/or the projection surface assembly 112 into the combined configuration, the controller 132 may instruct the projector 108 to project a first projection image onto the projection surface 113. The first projection image, in conjunction with the combined configuration, may produce a 3D visual effect. For example, the controller 132 may instruct the projector 108 to display the first projection image corresponding to water or lava. The first projection image in conjunction with the combined configuration of the projection surface assembly 112 and the dynamic surface assembly 116 may produce a 3D visual effect of water or lava.

Upon instructing the engagement or the projection surface actuators 152, 168 to translate the dynamic surface assembly 116 and/or the projection surface assembly 112 into the separated configuration, the controller 132 may instruct the projector 108 to project a second projection image onto the projection surface 113. The second projection image, in conjunction with the projection surface 113 in the separated configuration (e.g., wherein the projection surface 113 is flat), may produce a 2D visual effect or a regular projection. For example, the controller 132 may instruct the projector 108 to display the second projection image corresponding to stagnant ice, stagnant soil/sand, or another substantially flat visual.

In an embodiment, the memory device 196 may store instructions related to 3D projection mapping to be executed by the processing circuitry 192. For example, the DPSS 100 may include a sensor 200 communicatively coupled to the controller 132 and configured to perform surface analysis on the projection surface 113 in the combined configuration. That is, the sensor 200 may receive surface analysis data corresponding to the protrusions 180 on the second side 176 of the projection surface 113. Upon receiving the data, the sensor 200 may communicate or send a signal indicative of the data to the controller 132 to be stored within the memory device 196 and/or used within the processing circuitry 192. For example, the memory device 196 may include 3D projection mapping instructions configured to be executed by the processing circuitry 192 to adjust or change one or more parameters of the projector 108, based on the surface analysis data. The controller 132 may send the adjusted projector parameters to the projector 108 to provide a projected image based on the surface analysis data. For example, the projected image may be modeled or adjusted to dimensions of the protrusions 180, angles of the protrusions 180, textures of the projection surface 113, and so forth. In this way, the DPSS 100 may enhance guest experience by creating one or more 3D visual effects mapped to the 3D projection surface 113 in the combined configuration. It should be noted that the protrusions 180 may be analyzed before coming into view of the guests to allow time for provision of projection mapping data (e.g., location, deformation). Further, in some embodiments, the 3D features 136 may be analyzed while not engaged with the projection surface 113 (e.g., while on a side of the chassis 123 opposite the projection surface 113) to facilitate generating projection mapping data. For example, positioning of the 3D features 136, which may be dynamic (e.g., hinged, actuated, rotatable) may be detected by one or more sensors 200 on a back side of the chassis 123 relative to the projection surface 113 and known correlations (e.g., amount of deformation of the projection surface 113 by the detected 3D feature 136) with the projection surface 113 may be taken into account to generate appropriate (e.g., properly angled) and properly located image content.

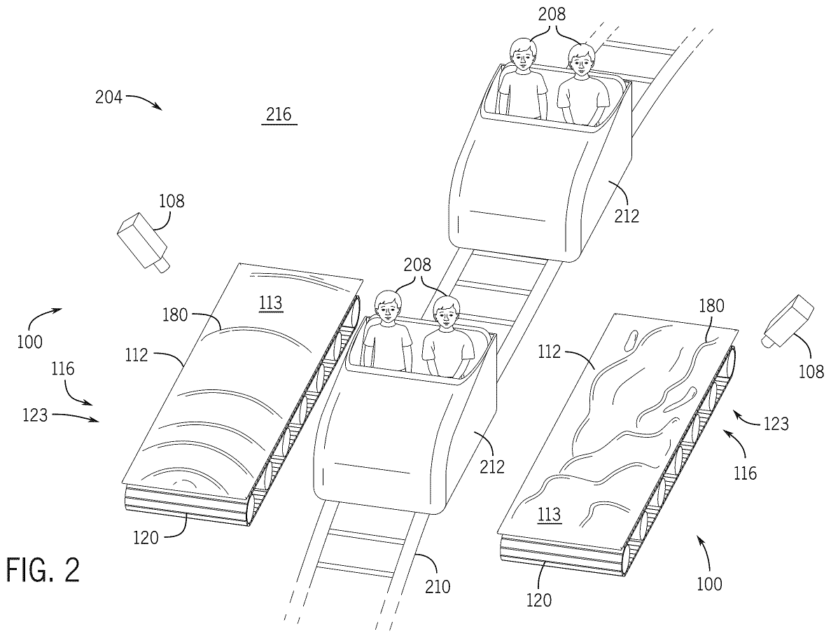

FIG. 2 is a schematic perspective view of an attraction 204 utilizing the DPSS 100, in accordance with an embodiment of the present disclosure. Specifically, FIG. 2 shows the attraction 204 (e.g., rollercoaster, omni mover ride) configured to transport or otherwise move one or more guests 208. The attraction 204 may include one or more ride vehicles 212 (e.g., cars, buses) configured to transport the guests 208 along a path 210 (e.g., a track) through an attraction environment 216. As will be appreciated, the attraction environment 216 may include decorations (e.g., themed décor), animated characters, lighting, sound effects, interactive displays, special effects, visual effects, and other attraction environment elements that may increase the guest experience during the attraction 204.

The attraction 204 may include one or more DPSS 100 configured to display a 2D or 3D visual effect to the guests 208. For example, one or more components of the DPSS 100 may be positioned adjacent to the path 210 and configured to provide visual effects to the guests 208 of the attraction 204 as the guests 208 pass by on the ride vehicles 212. In an embodiment, the projection surface assemblies 112 may be positioned on one or more sides of the path 210 and may extend along the floor of the attraction environment 216 to simulate a ground level of the attraction environment 216. The dynamic surface assemblies 116 may be positioned under the projection surface assemblies 112, out of view from the guests 208, and configured to translate (e.g., vertically translate) into the projection surface assemblies 112 to establish the combined configuration. In this way, the projection surface 113 may maintain a constant elevation relative to path 210 (and thus the guests 208 positioned on the path 210), appearing as the floor or a bottom of the attraction 204 and concealing or hiding the mechanisms of the DPSS 100 underneath.

During operation of the attraction 204 one or more projectors 108 may project one or more projection images onto the projection surfaces 113 to create one or more visual effects in manner discussed above. For example, in the combined configuration of the projection surface assembly 112 and the dynamic surface assembly 116, the protrusions 180 may extend into view of the guests 208. The projectors 108 may project the projection image onto the projection surface 113 including the protrusions 180 to create one or more 3D visual effects. For example, during operation of the attraction 204 the DPSS 100 may create 3D visual effects corresponding to dynamic or running water, such as waves. In this way, the DPSS 100 may provide an illusion that the ride vehicles 212 are floating or traversing through water, enhancing the attraction environment 216 and the guest experience. In an embodiment, during operation of the attraction 204, the DPSS 100 may create 3D visual effects corresponding to dynamic rocks or molten lava. In this way, the DPSS 100 may imitate the ride vehicles 212 traversing over molten lava, enhancing the attraction environment 216 and the guest experience.

Although the DPSS 100 is provided in the context of a floor or base, it will be appreciated that the DPSS 100 may be oriented in any suitable configuration. For example, the DPSS 100 may be positioned vertically, such as on a wall or in place of a wall. Further, the DPSS 100 may be positioned as a ceiling or above the guests 208.

While FIG. 2 provides an example in a context of a ride attraction (e.g., attraction 204), it should be appreciated that these techniques may be implemented in any suitable attraction or venue, such as in a walkthrough attraction in which the guests 208 walk along a pathway, a conveyor attraction in which the guests 208 are carried on a conveyor, a show performance, along with or adjacent a treadmill or stationary bike for exercise, and so forth.

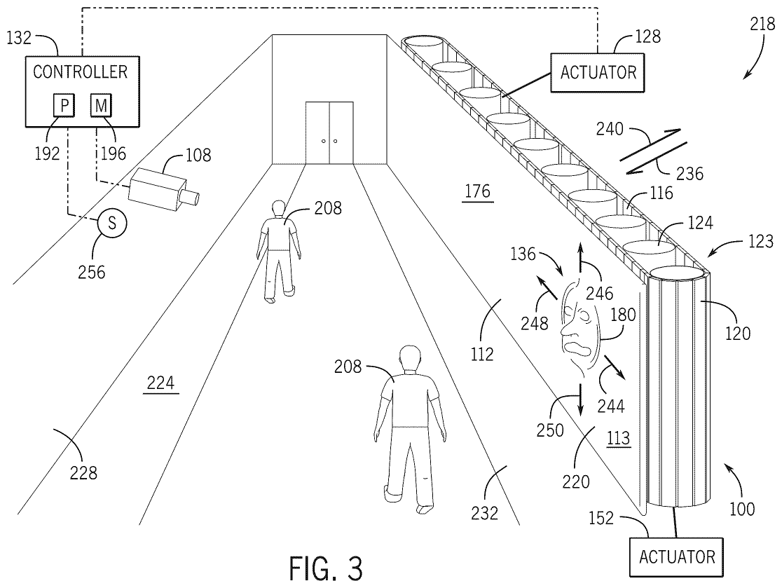

FIG. 3 illustrates an embodiment of the DPSS 100 utilized within a walkthrough attraction 218 or a conveyor attraction. In the present embodiment, the DPSS 100 imitates a wall 220 of a hallway 224 where guests 208 may walk through or may be conveyed through, such as in a haunted house. In some embodiments, the DPSS 100 may be positioned on a second wall 228, a floor 232, or a ceiling of the walkthrough attraction 218.

In the illustrated embodiment, the projection surface 113 may be fixedly located and may imitate the wall 220 of the walkthrough attraction 218, and the dynamic surface assembly 116 may be positioned behind the projection surface 113, hidden or concealed from guest view. The dynamic surface assembly 116 may translate horizontally, via the engagement actuator 152, in a first direction 236 towards the projection surface 113 into the combined configuration. Further, the dynamic surface assembly 116 may translate horizontally, via the engagement actuator 152, in a second direction 240, away from the projection surface 113, into the separated configuration. As discussed above, in the combined configuration, one or more 3D features 136 (hidden behind the projection surface 113) disposed on the dynamic surface 120 may protrude into the projection surface 113 to create one or more protrusions 180 (e.g., a protrusion shaped like a face) in a viewable side of the projection surface 113 (e.g., second side 176).

The projector 108 may project the projected image onto the projection surface 113 including the protrusions 180 to create one or more 3D visual effects to present to the guests 208. For example, in the illustrated embodiment, the 3D feature 136 of the dynamic surface assembly 116 may be structured as a face (e.g., human face), where in the combined configuration, the protrusion 180 may take the form of the 3D feature 136 (e.g., the face). The projector 108 may project a projected image including facial features, such as eyes, skin, hair, teeth, etc., onto the protrusion 180 to imitate a real-life face protruding through the wall 220 and towards the guests 208. In an embodiment, the projector 108 may project the projected image onto the projection surface 113 based on actuation of the dynamic surface actuator 128. For example, the controller 132 may be configured to instruct the projector 108 to project the projected image onto the projection surface when the dynamic surface actuator 128 is operating (e.g., based on an operating signal of the dynamic surface actuator 128) and the controller 132 may instruct the projector 108 to suspend projection or change the projection image when the dynamic surface actuator 128 is suspended.

As discussed above, the dynamic surface assembly 116 may include the dynamic surface actuator 128 configured to rotate one or more rollers 124 of the dynamic surface assembly 116. The one or more rollers 124 may circulate or rotate the dynamic surface 120 of the dynamic surface assembly 116 to further translate the 3D features 136 (and, thus, the protrusions 180) in a first direction 244 or a second direction 248 generally along the length of the hallway 224. As such, a 3D visual effect created by the DPSS 100 may appear to be moving along the wall 220 during the walkthrough attraction 218. Although the protrusion 180 is discussed in the context of a face, it will be appreciated that any shape or size of the 3D feature 136 (and associated protrusion 180) may be utilized within the DPSS 100, such as, other body parts (e.g., hands), animals (e.g., insects, mammals), imaginary or fictional creatures, inanimate items, elements, and so forth.

In an embodiment, the dynamic surface 120 of the dynamic surface assembly 116 may be configured to rotate or circulate in a vertical direction. For example, the dynamic surface actuator 128 may be configured to rotate one or more rollers 124 of the dynamic surface assembly 116 to circulate or rotate the dynamic surface 120 (and the protrusions 180) in a third direction 246 (e.g., upward relative to the direction of gravity) or a fourth direction 250 (e.g., downward relative to the direction of gravity) generally crosswise to the length of the hallway 224. In this way, a water fall themed 3D visual effect may be provided via the combined configuration of the DPSS 100.

In an embodiment, the protrusions 180 may be configured to “follow” or track a guest 208 of the walkthrough attraction 218. For example, a sensor 256 may be disposed in the hallway 224 and configured to detect a location and/or movement direction of the guest 208. For example, the sensor 252 may be a motion detecting sensor, a thermal sensor (e.g., infrared sensor), a microphone, a vision-based sensor (e.g., camera), a facial recognition sensor, an RFID sensor (e.g., for detecting an RFID ticket) or any combination thereof configured to detect the location and/or movement direction of the guest 208. Upon detecting the location and/or movement direction of the guest 208, the sensor 252 may communicate data indicative of the location and/or movement direction of the guest 208 to the controller 132. Based on the data indicative of the location and/or movement direction of the guest 208, the controller 132 may instruct the dynamic surface actuator 128 to move or translate the 3D features 136 and the corresponding protrusion 180. For example, the guest 208 walking through or conveyed through the hallway 224 may be followed by the protrusion 180 on the wall 220. Further, based on the data indicative of the location and/or movement direction of the guest 208, the controller 132 may instruct the engagement actuator 152 to transition the dynamic surface assembly 116 towards or away from the projection surface 113.

In an embodiment, one projection surface 113 may overlap or cover two or more dynamic surfaces assemblies 116. A first dynamic surface assembly 116 may be generally oriented to rotate or circulate a dynamic surface 120 vertically while a second dynamic surface assembly 116 may be generally oriented to rotate or circulate a dynamic surface 120 horizontally. A projection surface 113 may be disposed over both the first and second dynamic surfaces assemblies 116 to create one or more visual effects. For example, protrusions 180 on the first dynamic surface assembly 116 may imitate a dynamic visual effect in the vertical direction while protrusions 180 on the second dynamic surface assembly 116 may imitate a dynamic visual effect in the horizontal direction. Further, in an embodiment, the first dynamic surface assembly 116 may separate from the projection surface 113 in the separated configuration while the second dynamic surface assembly 116 may interact with the projection surface 113 in the combined configuration. As such, one side of the projection surface 113 may be 3D or “bumpy” and an opposite side of the projection surface 113 may be 2D or “smooth”. In this way, the projector 108 may provide a projection image onto the projection surface 113 that imitates both a 3D visual effect and a 2D visual effect. In an example, the DPSS 100 may present a visual effect that imitates ice (e.g., 2D visual effect) transitioning into flowing water (e.g., 3D visual effect), ground (e.g., 2D visual effect) transitioning into flowing lava (e.g., 3D visual effect), and so forth.

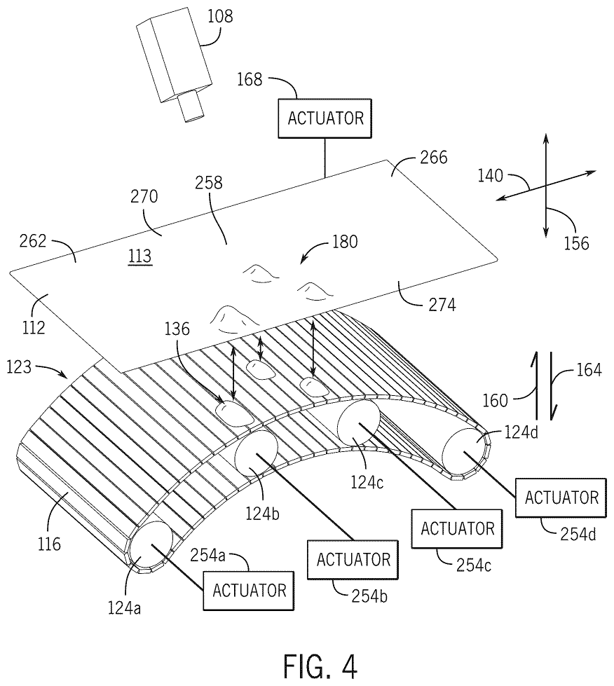

Referring now to FIG. 4, a schematic view of an embodiment of a DPSS 100 is shown. In an embodiment, the dynamic surface assembly 116 may be configured to change or adjust the shape or curvature of the dynamic surface assembly 116 to alter a visual effect in the combined configuration with the projection surface assembly 112. For example, one or more shape actuators 254 (illustrated using reference numerals 254a, 254b, 254c, 254d) may be coupled to the rollers 124 (illustrated using reference numerals 124a, 124b, 124c, 124d) or the chassis 123 of the dynamic surface assembly 116, where the shape actuators 254 may translate each roller of the one or more rollers 124 and/or the chassis 123 in the first direction 160 or the second direction 164 along the vertical axis 156 to alter or change the shape of the dynamic surface assembly 116. In the illustrated embodiment, the second and third rollers 124b, 124c may be positioned above (e.g., vertically above) the first and fourth rollers 124a, 124d. The controller 132 may instruct the corresponding actuators 254b and 254c to move the rollers 124b and 124c in the first direction 160 to combine or interact with the projection surface 113, while the actuators 245a and 245d do not move the rollers 124a and 124b or move in a second direction 164. As a result, the dynamic surface assembly 116 may include a hill shape. In the combined configuration with the projection surface assembly 112, the hill shaped dynamic surface 116 may cause protrusions 180 near a center 258 of the projection surface 113, and reduced or no protrusions 180 near the first and second sides 262, 266 of the projection surface 113. As such, during operation of the dynamic surface 120, the protrusions 180 may appear at the center 258 of the projection surface 113 and disappear (e.g., gradually disappear) as they move towards the first or second sides 262, 266 of the projection surface 113.

Although a hill shaped dynamic surface assembly 116 is described, it will be appreciated the dynamic surface assembly 116 may include any shape desirable. Indeed, each roller of the one or more rollers 124 may include a shape actuator 254 configured to translate the respective roller in the first or second directions 160, 164 to create a desired shape of the dynamic surface assembly 116 and create desired 3D visual effects. It should be noted that the projection surface assembly 112 may also utilize shape actuators 254 to change shape to, for example, conform with, compliment, or contrast with the shape of the dynamic surface assembly 116. Although FIG. 4 is discussed in the context of a DPSS 100 positioned horizontally or flat, it will be appreciated the DPSS 100 may be positioned vertically, such as in the context of a wall.

In an embodiment, the projection surface assembly 112 may tilt or angle relative to the dynamic surface assembly 116 to create a desired visual effect in combination with the dynamic surface assembly 116. For example, one or more actuators (e.g., projection surface actuator 168) may be coupled to a first side 262, a second side 266, a third side 270, and/or a fourth side 274 of the projection surface assembly 112. The one or more actuators may be configured to adjust a vertical position of sides 262, 266, 270, 274 to adjust a tilt or angle of the projection surface assembly 112 relative to the dynamic surface assembly 116. For example, an actuator coupled to the first side 262 may lower or translate the first side 262 in the second direction 164, while other actuators may remain at a common position. In this way, the first side 262 may contact or interact with the dynamic surface assembly 116 in the combined configuration while the second side 266 may not interact with the dynamic surface assembly 116. As such, visual effects such as a 2D image transitioning into a 3D image may be observed.

FIG. 5 illustrates a schematic perspective view of an embodiment of the dynamic projection surface system (DPSS) 100 transitioning between the combined configured and the separated configuration, in accordance with one or more aspects of this disclosure. For example, the controller 132 may instruct the engagement actuator 152 and/or the projection surface actuator 168 to translate the dynamic surface assembly 116 and/or the projection surface assembly 112 in the first direction 160 or the second direction 164, opposite the first direction 160, to interchange between the combined configuration and the separated configuration. As discussed above, the transition between the combined configured and the separated configuration and vice versa may enable one or more 2D and 3D visual effects to be projected onto the projection surface 113 to create a more immersive experience. Certain elements of the components are omitted in the illustrated embodiment for clarity, but it should be appreciated that the components of the DPSS 100 in the illustrated embodiment may be similar to those described above with reference to FIGS. 1, 2, 3, and 4 and/or may include similar elements.

While only certain features of the disclosure have been illustrated and described herein, many modifications and changes will occur to those skilled in the art. It is, therefore, to be understood that the appended claims are intended to cover all such modifications and changes as fall within the true spirit of the disclosure. It should be appreciated that any features shown and described with reference to FIGS. 1-5 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A dynamic projection surface system, comprising:
a projection surface assembly comprising one or more projection surfaces configured to display imagery;
a dynamic surface assembly configured to move relative to the one or more projection surfaces;
one or more three-dimensional (3D) features extending from one or more dynamic surfaces of the dynamic surface assembly, wherein the dynamic projection surface system is configured to translate at least the dynamic surface assembly or the projection surface assembly between a separated configuration in which the one or more projection surfaces is offset from the one or more dynamic surfaces and a combined configuration in which the one or more dynamic surfaces engages with the one or more projection surfaces such that the one or more 3D features protrude into the one or more projection surfaces; and
one or more projectors configured to project the imagery onto the one or more projection surfaces.

2. The dynamic projection surface system of claim 1, wherein the dynamic surface assembly is configured to translate toward and away from the projection surface assembly, which is fixedly located.

3. The dynamic projection surface system of claim 1, comprising a projection surface actuator configured to translate the projection surface assembly towards and away from the dynamic surface assembly.

4. The dynamic projection surface system of claim 1, wherein the one or more projectors is configured to provide first imagery in the separated configuration and second imagery in the combined configuration, wherein the first imagery corresponds to a 2D visual presenation and the second imagery corresponds to a 3D visual presentation.

5. The dynamic projection surface system of claim 1, wherein the one ore more dynamic surfaces comprise a belt, and wherein a dynamic surface actuator of the dynamic surface assembly is configured to move the belt around the dynamic surface assembly.

6. The dynamic projection surface system of claim 1, comprising a tension actuator configured to adjust a tension of the one or more projection surfaces between at least a taut condition and a slack condition.

7. The dynamic projection surface system of claim 1, wherein the one or more dynamic surfaces comprise a belt configured to extend around one or more rollers and the 3D features extend from a surface of the belt.

8. The dynamic projection surface system of claim 7, wherein the dynamic surface assembly comprises one or more shape actuators configured to adjust a relative position of at least one roller of the one or more rollers.

9. A dynamic projection surface system for an entertainment venue, the dynamic projection surface system comprising:
a dynamic surface assembly configured to move one or more three-dimensional (3D) features along a dynamic surface of the dynamic surface assembly;
a projection surface assembly comprising a projection surface configured to contact at least one of the one or more 3D features in a combined configuration in which the projection surface assembly and the dynamic surface assembly are engaged;
a first actuator configured to translate the dynamic surface and/or the projection surface between the combined configuration and a separated configuration in which the dynamic surface assembly is offset from the projection surface assembly; and
a projector configured to project imagery onto the projection surface.

10. The dynamic projection surface system of claim 9, wherein the projector is configured to perform three-dimensional projection mapping onto the projection surface in the combined configuration.

11. The dynamic projection surface system of claim 9, wherein the projection surface comprises elastic material and at least one of the one or more 3D features protrudes into the projection surface in the combined configuration.

12. The dynamic projection surface system of claim 9, comprising a controller communicatively coupled to the projector, the first actuator, and the dynamic surface assembly, wherein the controller is configured to:
control the projector to project first imagery onto the projection surface in the combined configuration; and
control the projector to project second imagery onto the projection surface in the separated configuration.

13. The dynamic projection surface system of claim 12, wherein the projector is configured to:
generate the first imagery based on projection mapping data acquired from a sensor configured to monitor the projection surface and/or the dynamic surface; and
generate the second imagery as 2D imagery.

14. The dynamic projection surface system of claim 9, wherein the projection surface assembly comprises:
a support coupled to the projection surface: and
a tension actuator coupled to the support and the projection surface, wherein the tension actuator is configured to adjust a tension of the projection surface.

15. The dynamic projection surface system of claim 9, wherein at least one 3D object of the one or more 3D objects comprises a light, a speaker, or a vibrational actuator.

16. The dynamic projection surface system of claim 9, comprising a controller configured to:
actuate the dynamic surface of the dynamic surface assembly to move the one or more 3D features relative to the projection surface assembly in the combined configuration; and
suspend operation of the dynamic surface of the dynamic surface assembly in the separated configuration.

17. A projection system comprising:
a projection surface assembly comprising a projection surface;
a projector configured to project a projection image onto the projection surface;
a dynamic surface assembly configured to interact with the projection surface assembly in a combined configuration, the dynamic surface assembly comprising:
one or more rollers;
a dynamic surface extending around the one or more rollers; and
one or more three-dimensional (3D) features coupled to the dynamic surface, wherein the one or more 3D features protrude into the projection surface in the combined configuration; and
a dynamic surface actuator coupled to at least one roller of the one or more rollers, wherein the dynamic surface actuator is configured to rotate the at least one roller to rotate the dynamic surface.

18. The projection system of claim 17, comprising a controller communicatively coupled to the projector and the dynamic surface actuator, wherein the controller is configured to instruct the projector to project the projection image based on an actuation of the dynamic surface actuator.

19. The projection system of claim 18, comprising a sensor communicatively coupled to the controller, wherein the sensor is configured to detect a location of a guest, wherein the controller is configured to:
receive data indicative of the location of the guest from the sensor; and
instruct the dynamic surface actuator to rotate the at least one roller based on the received data.

20. The projection system of claim 18, comprising an engagement actuator configured to translate the dynamic surface assembly towards the projection surface assembly into the combined configuration or away from the projection surface assembly into a separated configuration.
